(19) United States
(12) Patent Application Publication
(10) Pub. No.: US 2026/0137023 A1
(43) Pub. Date: May 21, 2026

(54) SYSTEMS, METHODS, AND DEVICES FOR INCREASING MACHINE OPERATING RANGE

(71) Applicant: Ag Leader Technology, Ames, IA (US)

(72) Inventor: John Howard, Ames, IA (US)

(21) Appl. No.: 19/397,422

(22) Filed: Nov. 21, 2025

Related U.S. Application Data
(60) Provisional application No. 63/723,400, filed on Nov. 21, 2024.

(51) Int. Cl. A01C 23/00; A01C 23/04

(52) U.S. Cl. CPC A01C 23/007; A01C 23/047

(57) ABSTRACT

Systems, devices, and methods are disclosed for increasing the operating range of agricultural liquid application equipment by combining pulse-width modulation (PWM) at individual nozzles with dynamic pressure range control at the boom or section level. A controller determines a pressure operating band based on nozzle attributes or operator input and coordinates pressure and PWM duty cycle to achieve target application rates while maintaining droplet size targets. In some implementations, the boom is sectioned, with section-specific pressure regulators enabling graduated pressure profiles for turn compensation.

### CROSS-REFERENCE TO RELATED APPLICATION(S)

This application claims the benefit under 35 U.S.C. § 119(e) to U.S. Provisional Application 63/723,400, filed Nov. 21, 2024, and entitled Systems, Methods, and Devices for Increasing Machine Operating Range using PWM and Dynamic Pressure Range Control, which is hereby incorporated herein by reference in its entirety for all purposes.

### TECHNICAL FIELD

The present disclosure relates to fluid application systems, devices, and methods, particularly for agricultural sprayers and other liquid application implements. More specifically, the disclosure concerns control architectures that combine pulse-width modulation (PWM) flow control with dynamic pressure range control to extend operating range, improve rate accuracy, and maintain target spray droplet size across varying operating conditions.

### BACKGROUND

Various agricultural sprayers would be known to those of skill in the art. A known sprayer 2 is shown in FIG. 1. In this known sprayer 2 the liquid product flows from a solution tank 4 to spray nozzles 10 for application. Various additional components may be included on a sprayer 2 such as ball valves, filters, chemical inductors, agitation and rinse circuits, and the like but are omitted in FIG. 1 for simplicity and clarity but would be understood and appreciated by those of skill in the art.

In this example of a sprayer 2, a remote chemical supply tank 4 is connected to the fill port 6 such that the liquid product may be pumped into the liquid solution tank 4. A pump 8 is used to move the liquid from the liquid solution tank 4 to the spray nozzles 10, such as through boom plumbing 12.

In certain sprayers 2, the speed of the pump 8 may be varied to control the flow rate of liquid to meet the required volume of liquid applied. A flow meter 14 may optionally be used as feedback to an electronic control system to determine adjustments to the pump 8 speed. Product flow rate may also be controlled by using an in-line servo valve, an excess flow by-pass valve, or by PWM (pulse width modulation) at individual nozzles.

Conventional liquid controllers control the volume of product dispensed by varying the flow by varying the speed of the liquid pump 8 and/or using servo style regulating valve 16 to modulate the liquid pump output, that is redirecting flow back to the tank 4 after the pump 8. Conventional liquid controllers have a limited turn down ratio of approximately 1.5:1-2:1, constraining the range of speeds and field conditions under which accurate application can be maintained without frequent nozzle changes or compromising droplet size. The turn down ratio range is limited due to the use of a fixed size orifice or spray nozzle.

### BRIEF SUMMARY

Disclosed herein are systems, devices, and methods that increase the operating range of agricultural liquid application equipment by coordinating PWM control of individual nozzles with dynamic pressure range control at the boom or section level. The system leverages sensor feedback, including at least one of pressure sensing and flow sensing, and optionally nozzle attribute data (e.g., pressure limits and droplet size curves), to determine a pressure operating band and PWM duty cycle distribution that collectively satisfy rate targets and droplet size targets over a wide range of operating conditions. In some implementations, the system automatically selects among droplet size targets based on field boundaries, headlands, buffer zones, adjacent sensitive crops, and other mapped data. In some implementations, the boom is divided into pressure-addressable sections to enable graduated pressure control across the boom for turn compensation and further increased effective turndown. In some further implementations, the controller prioritizes the lowest feasible duty cycle within the defined pressure band to reduce electrical current draw, which may be advantageous for autonomous or electric platforms.

The disclosed techniques can be integrated with a wide array of liquid application systems, including broadcast sprayers, planter-applied liquid systems, and liquid fertilizer implements, and can interoperate with guidance, mapping, and automation platforms.

In Example 1, a fluid application system comprising a boom having a plurality of dispense points, each dispense point including a pulse-width modulation (PWM) nozzle, a fluid circuit configured to deliver liquid from a tank to the boom, at least one pressure sensor configured to provide pressure feedback indicative of pressure in the fluid circuit at the boom or at a section of the boom, an electronic controller operatively coupled to the PWM nozzles and the at least one pressure sensor. and a regulating device operable by the electronic controller to adjust pressure supplied to the boom. The electronic controller is configured to: determine a dynamic pressure operating range having a minimum pressure bound and a maximum pressure bound and coordinate commanded pressure within the dynamic pressure operating range with PWM duty cycle allocation among the plurality of dispense points to achieve a target application rate while maintaining a droplet size target.

Example 2 relates to the system of any of Examples 1 and 3-12, wherein the electronic controller accesses stored PWM nozzle attribute data defining at least one of a minimum pressure limit, a maximum pressure limit, and a mapping between pressure and volumetric median droplet diameter (VMD), and determines the dynamic pressure operating range based on the stored nozzle attribute data.

Example 3 relates to the system of any of Examples 1-2 and 4-12, wherein the electronic controller selects the droplet size target based on mapped field attributes including at least one of headlands, buffer zones, and adjacent sensitive crops.

Example 4 relates to the system of any of Examples 1-3 and 5-12, wherein the boom comprises a plurality of pressure-addressable sections, each section including a pressure-reducing valve, and the electronic controller configured to command graduated section pressures across the boom to implement turn compensation.

Example 5 relates to the system of any of Examples 1˜4 and 6-12, wherein the electronic controller adjusts pressures in the plurality of pressure-addressable sections to increase available PWM duty cycle headroom at an outer portion of the boom during a turn and to decrease section pressures to prevent minimum-duty under-application at an inner portion of the boom during the turn.

Example 6 relates to the system of any of Examples 1-5 and 7-12, further comprising a flow meter configured to provide feedback on boom or pressure-addressable section flow, wherein the electronic controller uses flow meter feedback to refine PWM duty cycle allocation within the dynamic pressure operating range.

Example 7 relates to the system of any of Examples 1-6 and 8-12, wherein the electronic controller prioritizes lowest feasible PWM duty cycles within the dynamic pressure operating range.

Example 8 relates to the system of any of Examples 1-7 and 9-12, wherein coordination of commanded pressure and PWM duty cycle achieves an effective turndown ratio of at least 10:1.

Example 9 relates to the system of any of Examples 1-8 and 10-12, wherein the electronic controller implements a policy to resolve inner-boom and outer-boom actuation limit conflicts by automatically selecting slight over-application or under-application according to agronomic or regulatory priorities.

Example 10 relates to the system of any of Examples 1-9 and 11-12, wherein the fluid application system is integrated with at least one of a guidance platform, a mapping service, or an automation system, and the electronic controller is configured to receive geofencing data to automatically toggle among droplet size targets.

Example 11 relates to the system of any of Examples 1-10 and 12, wherein the regulating device comprises at least one of a pump with variable speed control and a regulating valve configured to divert flow to the tank.

Example 12 relates to the system of any of Examples 1-11, wherein the electronic controller comprises a processor and memory storing lookup tables of nozzle attributes and control logic including pressure control loops, PWM allocation algorithms, turn compensation logic, and fault handling.

In Example 13, a method of controlling a fluid application system having a boom with a plurality of dispense points each with a pulse-width modulation (PWM) nozzle, the method comprising: receiving pressure feedback from at least one pressure sensor associated with the boom or a section of the boom; determining, by an electronic controller, a dynamic pressure operating range with a minimum pressure bound and a maximum pressure bound; selecting a droplet size target based on nozzle attribute data or field attribute data; commanding a pressure regulating device to maintain pressure within the dynamic pressure operating range; and allocating PWM nozzle duty cycle among the plurality of dispense points to collectively satisfy a target application rate while maintaining the droplet size target.

Example 14 relates to the method of any of Examples 13 and 15-18, further comprising detecting a turn condition, commanding graduated section pressures across the boom to provide increased flow capacity at an outer portion of the boom and reduced pressure at an inner portion of the boom, and adjusting PWM nozzle duty cycles per dispense point to compensate for localized speed differentials during the turn.

Example 15 relates to the method of any of Examples 13-14 and 16-18, further comprising automatically toggling between droplet size targets based on geofenced buffer zones, headlands, or adjacent sensitive crops, and adjusting the dynamic pressure operating range accordingly.

Example 16 relates to the method of any of Examples 13-15 and 17-18, further comprising prioritizing lowest feasible PWM nozzle duty cycles within the dynamic pressure operating range.

Example 17 relates to the method of any of Examples 13-16 and 18, wherein the electronic controller comprises a processor and memory storing lookup tables of nozzle attributes and control logic including pressure control loops, PWM allocation algorithms, turn compensation logic, and fault handling.

Example 18 relates to the method of any of Examples 13-17, wherein the pressure regulating device comprises at least one of a pump with variable speed control and a regulating valve configured to divert flow to a tank.

In Example 19, a controller for a fluid application system comprising: one or more communication interfaces configured to receive pressure feedback from at least one pressure sensor and to transmit control commands to a pressure regulating device and to PWM nozzles at a plurality of dispense points, a memory storing nozzle attribute data including at least one of minimum pressure limits, maximum pressure limits, and mappings between pressure and volumetric median droplet diameter (VMD), and a processor configured to execute control logic that: determines a dynamic pressure operating range based on the nozzle attribute data; commands pressure within the dynamic pressure operating range; allocates PWM duty cycles among the plurality of dispense points to meet a target application rate while maintaining a droplet size target; and during turns, commands graduated section pressures across a boom and adjusts PWM duty cycles to increase effective turndown ratio and avoid saturation or minimum-duty conditions.

Example 20 relates to the controller of Example 19, wherein the pressure regulating device comprises at least one of a pump with variable speed control and a regulating valve configured to divert flow to a tank.

While multiple embodiments are disclosed, still other embodiments of the disclosure will become apparent to those skilled in the art from the following detailed description, which shows and describes illustrative embodiments of the invention. As will be realized, the disclosure is capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1 depicts an exemplary sprayer layout including a solution tank, pump, regulating valve, and boom plumbing terminating in nozzles, according to one implementation.

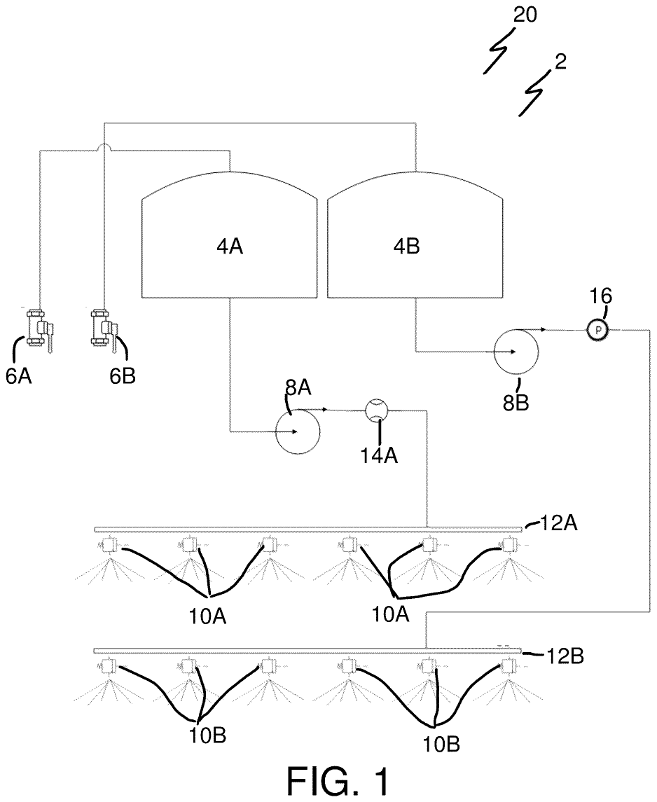

FIG. 2 shows a schematic diagram of a sprayer, according to one implementation.

FIG. 3 illustrates a boom configured with multiple pressure-controlled sections for graduated pressure across the boom, according to one implementation.

FIG. 4 shows settings, output, and performance for a conventional sprayer control.

FIG. 5 shows settings, output, and performance for independent pressure/flow control using PWM Nozzle having a single pressure setpoint.

FIG. 6 shows settings, output, and performance for independent pressure/flow control using PWM Nozzle implementing having a dynamic pressure range control.

FIG. 7 illustrates performance comparisons for the systems of FIGS. 2-4.

### DETAILED DESCRIPTION

The various devices, systems, and methods disclosed herein are configured to improve the effective operating range of a liquid controller by using independent pressure and flow volume control over a dynamic pressure range. The disclosed method can be used on any liquid application implement including sprayers, planter applied liquid, and liquid fertilizer application implements. Discussions herein regarding spray droplet size (VMD) are specific to sprayer use.

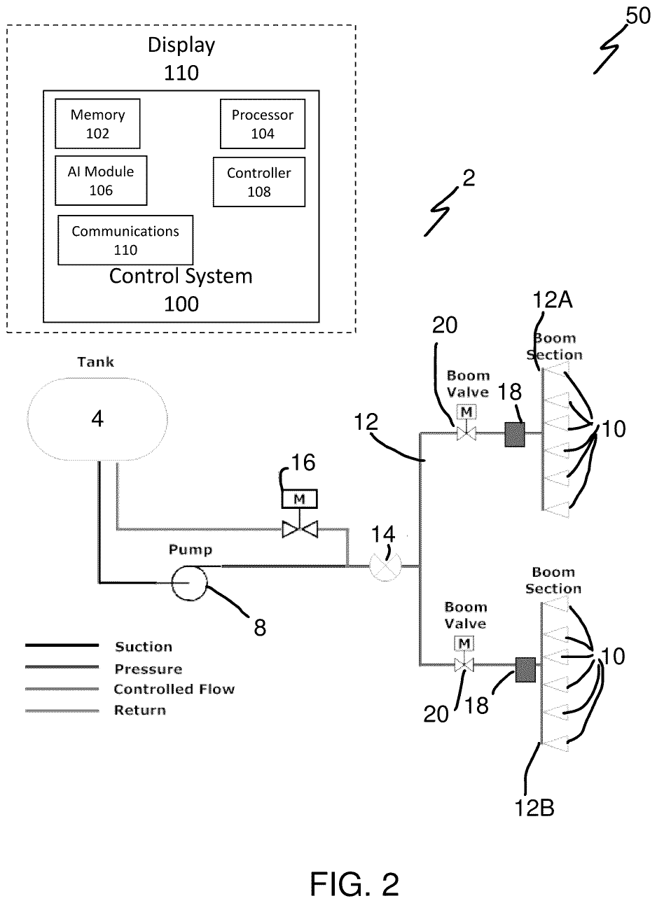

In various implementations, the liquid application system 50 includes a solution tank 4, a pump 8, boom 12 plumbing, and a plurality of nozzles 10 each associated with a PWM actuator, such as a solenoid-controlled valve, shown variously in FIG. 2. The system 50 may include one or more pressure sensors 18 on the boom 12, at one or more boom 12 sections 12A, 12B, and/or at the pump 8 discharge. The system 50 may also include a flow meter 14 providing feedback on overall or section flow. An electronic controller 108 or set of controllers executes control algorithms that regulate commanded pump 8 speed and/or a regulating valve 16, determine a dynamic pressure range, and allocate PWM duty cycle across nozzles 10 to satisfy flow and droplet size requirements.

The controller 108, as part of a control system 100, may access stored nozzle 10 attribute data defining, for a given nozzle model and size, the minimum and maximum pressure limits, as well as a mapping between pressure and volumetric median droplet diameter (VMD), or categorical droplet sizes (e.g., fine, medium, coarse). These attributes may be pre-loaded, updated via a communication link 110, or selected by the operator. The controller 108 may also access agronomic or regulatory parameters, such as required droplet size in buffer zones, neighboring sensitive crop areas, or headlands. Based on these inputs, the controller 108 sets a droplet size target and resolves a compatible pressure operating band.

In various implementations, the controller 108 is in communication with a processor 104 configured to execute various commands to execute the various steps and processes described herein. In certain implementations, the attributes and other data, as would be understood, are stored in a system memory 102, which may be an on-board memory, cloud based, or any other form of memory 102, that would be appreciated by those of skill in the art.

Certain of the disclosed implementations can be used in conjunction with any of the devices, systems or methods taught or otherwise disclosed in U.S. Pat. No. 10,684,305 issued Jun. 16, 2020, entitled “Apparatus, Systems and Methods for Cross Track Error Calculation From Active Sensors,” U.S. patent application Ser. No. 16/121,065, filed Sep. 4, 2018, entitled “Planter Down Pressure and Uplift Devices, Systems, and Associated Methods,” U.S. Pat. No. 10,743,460, issued Aug. 18, 2020, entitled “Controlled Air Pulse Metering apparatus for an Agricultural Planter and Related Systems and Methods,” U.S. Pat. No. 11,277,961, issued Mar. 22, 2022, entitled “Seed Spacing Device for an Agricultural Planter and Related Systems and Methods,” U.S. patent application Ser. No. 16/142,522, filed Sep. 26, 2018, entitled “Planter Downforce and Uplift Monitoring and Control Feedback Devices, Systems and Associated Methods,” U.S. Pat. No. 11,064,653, issued Jul. 20, 2021, entitled “Agricultural Systems Having Stalk Sensors and/or Data Visualization Systems and Related Devices and Methods,” U.S. Pat. No. 11,297,768, issued Apr. 12, 2022, entitled “Vision Based Stalk Sensors and Associated Systems and Methods,” U.S. patent application Ser. No. 17/013,037, filed Sep. 4, 2020, entitled “Apparatus, Systems and Methods for Stalk Sensing,” U.S. patent application Ser. No. 17/226,002 filed Apr. 8, 2021, and entitled “Apparatus, Systems and Methods for Stalk Sensing,” U.S. Pat. No. 10,813,281, issued Oct. 27, 2020, entitled “Apparatus, Systems, and Methods for Applying Fluid,” U.S. patent application Ser. No. 16/371,815, filed Apr. 1, 2019, entitled “Devices, Systems, and Methods for Seed Trench Protection,” U.S. patent application Ser. No. 16/523,343, filed Jul. 26, 2019, entitled “Closing Wheel Downforce Adjustment Devices, Systems, and Methods,” U.S. patent application Ser. No. 16/670,692, filed Oct. 31, 2019, entitled “Soil Sensing Control Devices, Systems, and Associated Methods,” U.S. patent application Ser. No. 16/684,877, filed Nov. 15, 2019, entitled “On-The-Go Organic Matter Sensor and Associated Systems and Methods,” U.S. Pat. No. 11,523,554, issued Dec. 13, 2022, entitled “Dual Seed Meter and Related Systems and Methods,” U.S. patent application Ser. No. 16/891,812, filed Jun. 3, 2020, entitled “Apparatus, Systems and Methods for Row Cleaner Depth Adjustment On-The-Go,” U.S. Pat. No. 11,678,607, issued Jun. 20, 2023, entitled “Apparatus, Systems, and Methods for Eliminating Cross-Track Error,” U.S. patent application Ser. No. 16/921,828, filed Jul. 6, 2020, entitled “Apparatus, Systems and Methods for Automatic Steering Guidance and Visualization of Guidance Paths,” U.S. Pat. No. 12,353,210, issued Jul. 8, 2025, entitled “Apparatus, Systems and Methods for Automated Navigation of Agricultural Equipment,” U.S. patent application Ser. No. 16/997,361, filed Aug. 19, 2020, entitled “Apparatus, Systems and Methods for Steerable Toolbars,” U.S. Pat. No. 11,785,881, issued Oct. 17, 2023, entitled “Adjustable Seed Meter and Related Systems and Methods,” U.S. patent application Ser. No. 17/011,737, filed Sep. 3, 2020, entitled “Planter Row Unit and Associated Systems and Methods,” U.S. Pat. No. 11,877,530 issued Jan. 23, 2024, entitled “Agricultural Vacuum and Electrical Generator Devices, Systems, and Methods,” U.S. patent application Ser. No. 17/105,437, filed Nov. 25, 2020, entitled “Devices, Systems and Methods For Seed Trench Monitoring and Closing,” U.S. patent application Ser. No. 17/127,812, filed Dec. 18, 2020, entitled “Seed Meter Controller and Associated Devices, Systems and Methods,” U.S. patent application Ser. No. 17/132,152, filed Dec. 23, 2020, entitled “Use of Aerial Imagery For Vehicle Path Guidance and Associated Devices, Systems, and Methods,” U.S. patent application Ser. No. 17/164,213, filed Feb. 1, 2021, entitled “Row Unit Arm Sensor and Associated Systems and Methods,” U.S. Pat. No. 12,268,115, issued Apr. 8, 2025, entitled “Planter Obstruction Monitoring and Associated Devices and Methods,” U.S. patent application Ser. No. 17/225,586, filed Apr. 8, 2021, entitled “Devices, Systems, and Methods for Corn Headers,” U.S. Pat. No. 11,758,848, issued Sep. 19, 2023, entitled “Devices, Systems, and Methods for Sensing the Cross Sectional Area of Stalks,” U.S. patent application Ser. No. 17/323,649, filed May 18, 2021, entitled “Assisted Steering Apparatus and Associated Systems and Methods,” U.S. patent application Ser. No. 17/369,876, filed Jul. 7, 2021, entitled “Apparatus, Systems, and Methods for Grain Cart-Grain Truck Alignment and Control Using GNSS and/or Distance Sensors,” U.S. patent application Ser. No. 17/381,900, filed Jul. 21, 2021, entitled “Visual Boundary Segmentations and Obstacle Mapping for Agricultural Vehicles,” U.S. patent application Ser. No. 17/461,839, filed Aug. 30, 2021, entitled “Automated Agricultural Implement Orientation Adjustment System and Related Devices and Methods,” U.S. Pat. No. 12,414,505, issued Sep. 16, 2025, entitled “Apparatus, Systems, and Methods for Row-by-Row Control of a Harvester,” U.S. patent application Ser. No. 17/526,947, filed Nov. 15, 2021, entitled “Agricultural High Speed Row Unit,” U.S. patent application Ser. No. 17/556,506, filed Dec. 20, 2021, entitled “Devices, Systems, and Method For Seed Delivery Control,” U.S. patent application Ser. No. 17/576,463, filed Jan. 14, 2022, entitled “Apparatus, Systems, and Methods for Row Crop Headers,” U.S. Pat. No. 12,403,950, issued Sep. 2, 2025, entitled “Automatic Steering Systems and Methods,” U.S. patent application Ser. No. 17/742,373, filed May 11, 2022, entitled “Calibration Adjustment for Automatic Steering Systems,” U.S. patent application Ser. No. 17/902,366, filed Sep. 2, 2022, entitled “Tile Installation System with Force Sensor and Related Devices and Methods,” U.S. patent application Ser. No. 17/939,779, filed Sep. 7, 2022, entitled “Row-by-Row Estimation System and Related Devices and Methods,” U.S. patent application Ser. No. 18/215,721, filed Jun. 28, 2023, entitled “Seed Tube Guard and Associated Systems and Methods of Use,” U.S. patent application Ser. No. 18/087,413, filed Dec. 22, 2022, entitled “Data Visualization and Analysis for Harvest Stand Counter and Related Systems and Methods,” U.S. patent application Ser. No. 18/097,804, filed Jan. 17, 2023, entitled “Agricultural Mapping and Related Systems and Methods,” U.S. patent application Ser. No. 18/101,394, filed Jan. 25, 2023, entitled “Seed Meter with Integral Mounting Method for Row Crop Planter and Associated Systems and Methods,” U.S. patent application Ser. No. 18/102,022, filed Jan. 26, 2023, entitled “Load Cell Backing Plate and Associated Devices, Systems, and Methods,” U.S. patent application Ser. No. 18/116,714, filed Mar. 2, 2023, entitled “Cross Track Error Sensor and Related Devices, Systems, and Methods,” U.S. patent application Ser. No. 18/203,206, filed May 30, 2023, entitled “Seed Tube Camera and Related Devices, Systems and Methods,” U.S. patent application Ser. No. 18/209,331, filed Jun. 13, 2023, entitled “Apparatus, Systems and Methods for Image Plant Counting,” U.S. patent application Ser. No. 18/217,216, filed Jun. 30, 2023, entitled “Combine Unloading On-The-Go with Bin Level Sharing and Associated Devices, Systems, and Methods,” U.S. patent application Ser. No. 18/229,974, filed Aug. 3, 2023, entitled “Hydraulic Cylinder Position Control for Lifting and Lowering Towed Implements,” U.S. patent application Ser. No. 18/230,534, filed Aug. 4, 2023, entitled “Single-Step Seed Placement in Furrow and Related Devices, Systems, and Methods,” U.S. patent application Ser. No. 18/238,344, filed Aug. 25, 2023, entitled “Combine Yield Monitor Automatic Calibration System and Associated Devices and Methods,” U.S. patent application Ser. No. 18/367,929, filed Sep. 13, 2023, entitled “Hopper Lid with Magnet Retention and Related Systems and Methods,” U.S. patent application Ser. No. 18/516,514, filed Nov. 21, 2023, entitled “Stalk Sensors and Related Devices, Systems, and Methods,” U.S. patent application Ser. No. 18/441,708, filed Feb. 14, 2024, entitled “Liquid Flow Meter and Flow Balancer and Associated Devices, Systems, and Methods,” U.S. patent application Ser. No. 18/662,800, filed May 13, 2024, entitled “Devices, Systems, and Methods for Providing Yield Maps,” U.S. patent application Ser. No. 18/665,305, filed May 15, 2024, entitled “Devices, Systems, and Methods for Agricultural Guidance and Navigation,” U.S. patent application Ser. No. 18/761,041, filed Jul. 1, 2024, entitled “Ring Assembly For Automatic and/or Assisted Steering and Associated Systems and Methods,” U.S. patent application Ser. No. 18/766,374, filed Jul. 8, 2024, entitled “Assisted Steering Systems and Associated Devices and Methods for Agricultural Vehicles,” U.S. patent application Ser. No. 18/929,309, filed Oct. 28, 2024, entitled “Agricultural Implement Position Sensor and Related Devices, Systems, and Methods,” U.S. patent application Ser. No. 18/962,799, filed Nov. 27, 2024, entitled “Devices, Systems and Methods for Guidance Line Shifting,” U.S. patent application Ser. No. 18/974,482, filed Dec. 9, 2024, entitled “Header Height Control Devices, Systems and Methods,” U.S. patent application Ser. No. 18/980,728, filed Dec. 13, 2024, entitled “Deck Plate Spacing Sensors and Related Devices, Systems, and Methods,” U.S. patent application Ser. No. 19/041,787, filed Jan. 30, 2025, entitled “Grain Cart Unloading Sensor and Unload Control System and Associated Devices and Methods,” U.S. patent application Ser. No. 19/207,115, filed May 13, 2025, entitled “Devices, Systems, and Methods for Planter and Seed Trench Imaging and Analysis,” U.S. patent application Ser. No. 19/219,718, fled May 27, 2025, entitled “Devices, Systems, and Methods for Agricultural Navigation and Positioning,” U.S. patent application Ser. No. 19/226,004, filed Jun. 2, 2025, entitled “Devices, Systems, and Methods for Machinery Monitoring and Reporting,” U.S. Patent Application 63/667,546, filed Jul. 3, 2024, entitled “Cover for Port Openings,” U.S. patent application Ser. No. 19/260,159, filed Jul. 3, 2025, entitled “Agricultural Seed Meters and Related Devices, Systems and Methods,” U.S. patent application Ser. No. 19/297,963, filed Aug. 12, 2025, entitled “Agricultural Navigation and Steering Systems, Devices and Methods,” U.S. patent application Ser. No. 19/305,530, filed Aug. 20, 2025, entitled “Crop Sensor Wands and Related Devices, Systems, and Methods,” U.S. patent application Ser. No. 19/366,202, filed Oct. 22, 2025, entitled “Crop Sensors and Related Devices, Systems, and Methods,” U.S. patent application Ser. No. 19/367,363, filed Oct. 23, 2025, entitled “Agricultural Sprayer Sensor and Related Devices, Systems, and Methods,” U.S. patent application Ser. No. 19/390,280, filed Nov. 14, 2025, entitled “Liquid Product Distribution for Agricultural Spraying Systems and Related Devices and Methods,” U.S. patent application Ser. No. 19/396,099, filed Nov. 20, 2025, entitled “Sprayer Nozzle Devices and Related System and Methods,” U.S. patent application Ser. No. 19/396,047, filed Nov. 20, 2025, entitled “Agricultural Harvesting Systems and Related Devices and Methods,” U.S. Patent Application 63/727,579, filed Dec. 3, 2024, entitled “Smart Shift for Automatic AB Line Adjustment in Agricultural Operations and Related Devices and Methods,” U.S. Patent Application 63/752,279, filed Jan. 31, 2025, entitled “System and Automatic Adjustment to Target Pressure and Related Devices and Methods,” U.S. Patent Application 63/752,341, filed Jan. 31, 2025, entitled “Harvester Liquid Application System, Devices, and Methods,” U.S. Patent Application 63/753,258, filed Feb. 3, 2025, entitled “Agricultural Navigation Methods, Devices, and Systems,” U.S. Patent Application 63/753,201, filed Feb. 3, 2025, entitled “Agricultural Mapping and Related Devices, Systems, and Methods” U.S. Patent Application 63/755,675, filed Feb. 7, 2025, entitled “Remote Assistance for Agricultural Display Methods and Related Devices and Systems,” U.S. Patent Application 63/757,242, filed Feb. 11, 2025, entitled “Seed Meter,” U.S. Patent Application 63/757,434, filed Feb. 12, 2025, entitled “Grain Fill Sensor,” U.S. Patent Application 63/760,907, filed Feb. 20, 2025, entitled Agricultural Yield Monitoring and Estimation Devices, Systems, and Methods,” U.S. Patent Application 63/816,284, filed Jun. 2, 2025, entitled “Agricultural Guidance and Navigation Systems, Methods, and Devices,” U.S. Patent Application 63/817,692, filed Jun. 4, 2025, entitled “Intelligent Steering System for Sprayers and Tractors in Standing Crops,” U.S. Patent Application 63/818,248, filed Jun. 5, 2025, entitled “Devices, Systems, and Methods for Determining Implement Pose,” U.S. Patent Application 63/906,692, filed Oct. 28, 2025, entitled “Agricultural Alignment System and Related Devices and Methods,” U.S. Patent Application 63,906,646, filed Oct. 28, 2025, entitled “Automated Grail Filling System and Related Devices and Methods,” each of which is incorporated herein by reference.

As would be understood, PWM-based liquid controllers have improved the effective operating range when compared to conventional liquid controllers by controlling to a user selected boom pressure by varying the speed of the liquid pump or modulating the pump output using a servo style valve. A pressure sensor is often used as feedback in this loop of control in these instances. The operating range of a system with PWM-based liquid controllers can also be improved by modulating the duty cycle of a PWM valve at each point of dispense, (spray nozzle, orifice, knife) to control the volume of product dispensed. A flow meter may be used as feedback in the loop of control in these instances.

These PWM-based liquid controllers have approximately an 8:1 turn down ratio. This is due to the PWM valve creating a variable sized orifice at each point of dispense. This represents over a 400% increase in operating range as compared to a conventional liquid control system.

As described herein, an additional improvement in control system 100 performance can be achieved by using PWM control but instead of controlling the liquid pressure to a single setpoint that is defined by the user, the system 50 is configured to control pressure within a dynamic pressure range. The range of pressures may be determined by either: a user defined setting for minimum and maximum operating pressure or nozzle/orifice information optionally stored in the control system 100 memory 102. Nozzle/orifice information may include, but is not limited to, minimum pressure limit of nozzle; maximum pressure limit of the nozzle; and/or the spray droplet size (VMD) associated with one of more pressure ranges for a specific nozzle/orifice.

PWM control combined with dynamic pressure range control may have a turn down ratio of approximately 10:1-15:1. This represents a 500%-700% increase in operating range as compared to a conventional liquid control system.

Unlike single-pressure-setpoint PWM systems, the disclosed controller 108 regulates the boom 12 or section pressure within a dynamic range bounded by minimum and maximum limits. The bounds may reflect nozzle 10 constraints, desired droplet size categories, and environmental or agronomic directives. Within the permissible range, the controller 108 modulates commanded pressure and PWM duty cycle jointly to achieve target application rates across a spectrum of ground speeds and field conditions.

For example, in straight-line operation at moderate speeds, the controller 108 may select a mid-range pressure supporting the target VMD and operate nozzles at a moderate duty cycle. As ground speed increases, rather than saturating PWM duty cycle at the existing pressure, the controller 108 increases pressure within the permissible range to expand the effective flow capacity and keep duty cycle within a controllable regime. Conversely, at lower speeds or when duty cycles fall near minimum thresholds, the controller 108 reduces pressure to maintain valve authority while preserving droplet size objectives.

By coordinating these parameters, the system 50 achieves a turndown ratio approximately in the range of 10:1 to 15:1, representing a significant improvement over both traditional regulating valve systems and fixed-pressure PWM systems. This extended range reduces the frequency of nozzle changes, supports higher productivity, and maintains droplet size specifications more consistently.

That is, as compared to conventional and single pressure setpoint PWM-based controller, the disclosed system 50, and associated methods and device, increase the operating range of the machine. Increased operating range supports higher productivity and profit. For the end user this has potential to make nozzle or orifice selection easier due to increase effective operating range.

In various further implementation, the system 50 may control spray application using target spray droplet settings. Previously, this was done in an abstracted sense by setting a target pressure setting in PWM spray rate controller. Various features of the disclosed system 50 include a user setting for spray droplet size, optionally stored in spray nozzle attributes; a user feature to allow toggling between multiple spray droplet sizes based upon field boundaries, headlands, buffer zones and other mapped data, aggregate mapped data served to the display by a web service or other method of communication; and system automation of toggling between spray droplet sizes based upon the attributes listed above.

These and other implementations simplify the task of making sure the system 50 user is spraying the correct spray droplet size for the particular chemical in use, field attributes such as buffer zones and headlands, and adjacent sensitive crops.

By directly selecting VMD instead of having to look that information up and set an operating pressure or pressure range the system 50 is easier to run and eliminates human error. By automatically switching between VMD based upon field attributes the system 50 reduces the risk of off target application by eliminating human error of selecting the wrong VMD (pressure) or forgetting to change VMD (pressure).

In various further implementations, the system 50 includes a turn compensation feature for PWM sprayer control using a graduated duty cycle across the boom 12 to vary the flow of each nozzle 10 when applying and driving curved sections of the field.

During turns, outer boom 12 segments traverse faster than inner segments, creating differing local application requirements. PWM-only systems adjust duty cycles across nozzles to account for speed differentials, but may encounter saturation at the outer end or minimum duty limits at the inner end. In such cases, the disclosed controller 108 dynamically adjusts pressure to expand or contract available PWM actuation headroom. When the outer boom duty cycle approaches its maximum, the controller 108 can increase pressure within the defined range to supply additional flow. When the inner boom duty cycle approaches a minimum, the controller 108 can reduce pressure to prevent under-application.

In some implementations, the boom 12 is partitioned into multiple sections 12A, 12B each equipped with a pressure-reducing valve 20 or similar metering device downstream of a common supply. The controller 108 commands graduated section pressures to approximate a pressure profile across the boom width. This stepwise pressure grading, combined with per-nozzle PWM, further broadens the controllable range during curved path operation and reduces the likelihood of saturation or minimum-duty conditions at extremes. A user-selectable policy or automated heuristic may resolve conflicts when both inner and outer sections approach actuation limits, for example by prioritizing slight over- or under-application in a controlled manner consistent with agronomic or regulatory priorities.

Depending upon the severity of the curve one of both of the following may happen causing the operator/application vehicle or implement to speed up or slow down to maintain the proper application rate (1) some portion of the outer end of the boom 12 is at max duty cycle and still underapplying or (2) some portion of the inner end of the boom 12 is at minimum duty cycle and still under applying.

In the case of the outer boom underapplying, the system 50 causes the pressure to be increased to correct application rate error. In the case of the inner boom under applying, the system 50 causes the pressure to be decreased to correct application rate error. If both, the outer end and inner end of the boom 12 are at limit of duty cycle range, a user setting may optionally choose between erroring by over or under application and making the change to boom 12 pressure. In various implementations, the system 50 may automatically or semi-automatically adjust the pressure settings, including selecting over or under application based on one or more of past data, user selection, and machine learning.

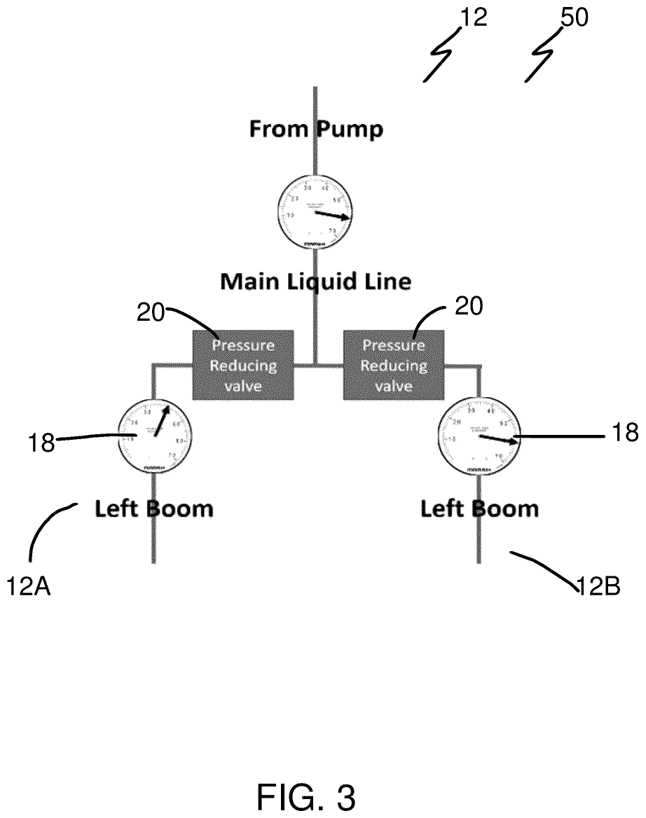

In various further implementations, the system 50 may be configured to split the boom 12 into multiple sections 12A, 12B with a pressure decreasing valve 20 at each section 12A, 12B, shown for example in FIG. 2 and FIG. 3. This configuration may allow for graduating the pressure across the width of the boom 12 in a step fashion to further broaden the turn down ratio of control.

In these and other implementations, the system 50 may support the full range of flow requirement without the machine operator making compromises on speed or choice between over or under application.

In still further implementations, the system 50 may allow for electrical current requirements for PWM controllers to be minimized by always using the lowest possible duty and modulating spray pressure to meet application requirements. As autonomous and electric implements become more common, limiting current consumption on those implements will be important to maximize battery life.

In various implementations, the system 50 includes various software, hardware, and firmware components needed to execute the programs and methods of the system. Optionally, the system may include a communications component configured to convey data from the cameras to a tractor/display/cloud for further processing by the processor.

The display may optionally include a communications component configured to send and receive instructions for operation of the system, harvester, and components thereof. The display may also optionally include a graphical user interface (GUI), a memory/storage, a global positioning system (GPS), and other components necessary to effectuate the methods of the system.

The system may be implemented with one or more embedded controllers, displays, and communication buses. Software components include control loops for pressure and PWM allocation, lookup tables and interpolation for nozzle attributes, turn compensation logic, geo-fencing and attribute-triggered droplet size selection, power management, and fault handling. The system may communicate with tractor or implement networks, GNSS receivers, and mapping services. Graphical user interfaces can present current pressure ranges, droplet size modes, duty cycle distributions, and alerts indicating when operating limits are approached.

The disclosed methods can be used on sprayers, planter-applied liquid systems, and liquid fertilizer implements. The system may interoperate with turn compensation systems, row-by-row control architectures, guidance and navigation platforms, and application mapping tools. Pressure sensing can be implemented at the pump, boom, and/or sections; flow sensing can be centralized or distributed. Control authority may reside in a single master controller or be distributed among section controllers with coordination over a shared bus. Variations that maintain the core concept of combined dynamic pressure band control with PWM-based point-of-dispense modulation fall within the scope of this disclosure.

### EXAMPLES

Examples given herein are indicative of a 10 GPA sprayer application targeting a medium VMD.

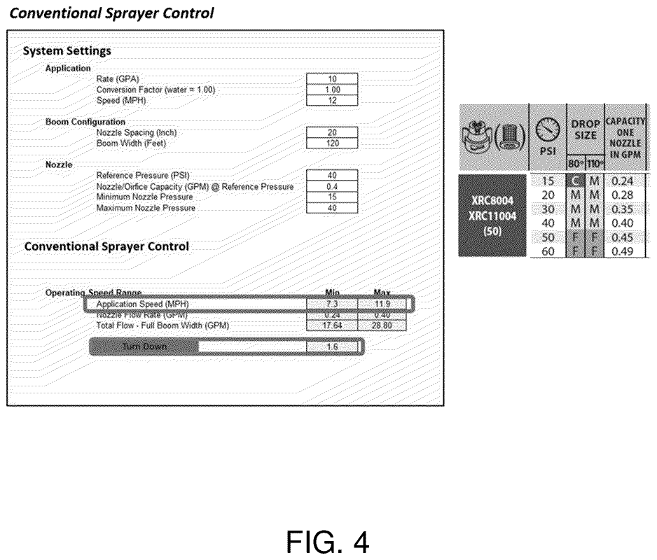

FIG. 4 shows the turn down ratio and operating characteristics for a system implementing conventional sprayer control.

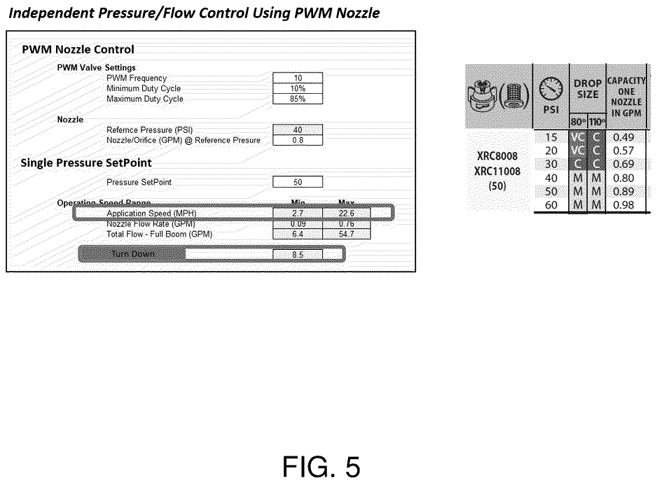

FIG. 5 shows a turn down ratio and operating characteristics for a system implementing a PWM nozzle with a single, fixed pressure set point.

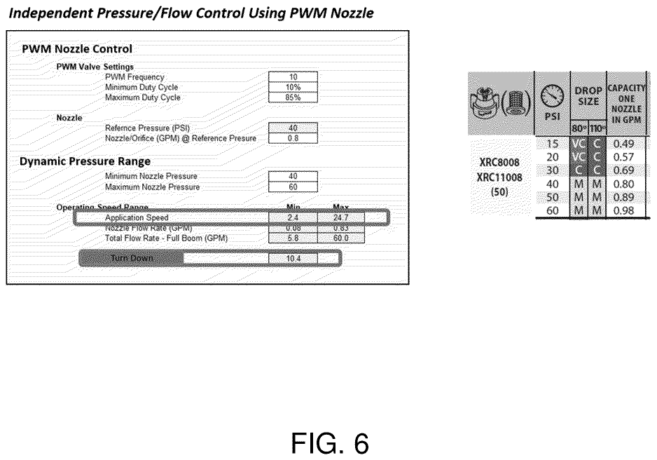

FIG. 6 shows a turn down ratio and operating characteristics for a system implementing a PWM nozzle with dynamic pressure range control.

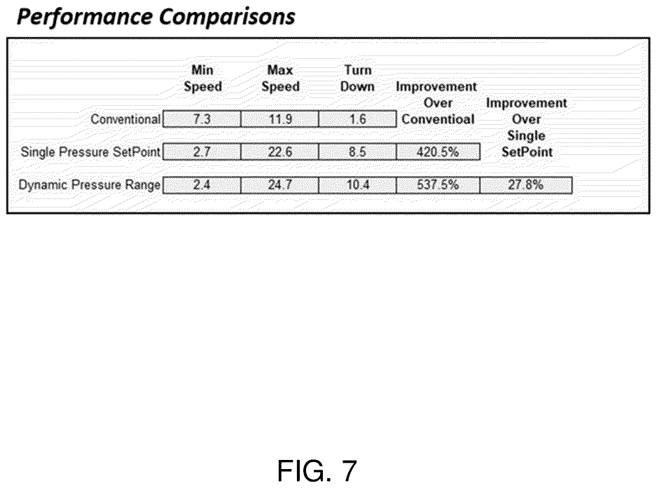

FIG. 7 provides a comparison of the operating characteristics and turn down for the systems of FIGS. 4-6.

Although the disclosure has been described with references to various embodiments, persons skilled in the art will recognize that changes may be made in form and detail without departing from the spirit and scope of this disclosure.

What is claimed is:

1. A fluid application system comprising:
(a) a boom having a plurality of dispense points, each dispense point including a pulse-width modulation (PWM) nozzle;
(b) a fluid circuit configured to deliver liquid from a tank to the boom;
(c) at least one pressure sensor configured to provide pressure feedback indicative of pressure in the fluid circuit at the boom or at a section of the boom;
(d) an electronic controller operatively coupled to the PWM nozzles and the at least one pressure sensor; and
(e) a regulating device operable by the electronic controller to adjust pressure supplied to the boom,
wherein the electronic controller is configured to:
determine a dynamic pressure operating range having a minimum pressure bound and a maximum pressure bound; and
coordinate commanded pressure within the dynamic pressure operating range with PWM duty cycle allocation among the plurality of dispense points to achieve a target application rate while maintaining a droplet size target.

2. The system of claim 1, wherein the electronic controller accesses stored PWM nozzle attribute data defining at least one of a minimum pressure limit, a maximum pressure limit, and a mapping between pressure and volumetric median droplet diameter (VMD), and determines the dynamic pressure operating range based on the stored nozzle attribute data.

3. The system of claim 1, wherein the electronic controller selects the droplet size target based on mapped field attributes including at least one of headlands, buffer zones, and adjacent sensitive crops.

4. The system of claim 1, wherein the boom comprises a plurality of pressure-addressable sections, each section including a pressure-reducing valve, and the electronic controller configured to command graduated section pressures across the boom to implement turn compensation.

5. The system of claim 4, wherein the electronic controller adjusts pressures in the plurality of pressure-addressable sections to increase available PWM duty cycle headroom at an outer portion of the boom during a turn and to decrease section pressures to prevent minimum-duty under-application at an inner portion of the boom during the turn.

6. The system of claim 1, further comprising a flow meter configured to provide feedback on boom or pressure-addressable section flow, wherein the electronic controller uses flow meter feedback to refine PWM duty cycle allocation within the dynamic pressure operating range.

7. The system of claim 1, wherein the electronic controller prioritizes lowest feasible PWM duty cycles within the dynamic pressure operating range.

8. The system of claim 1, wherein coordination of commanded pressure and PWM duty cycle achieves an effective turndown ratio of at least 10:1.

9. The system of claim 1, wherein the electronic controller implements a policy to resolve inner-boom and outer-boom actuation limit conflicts by automatically selecting slight over-application or under-application according to agronomic or regulatory priorities.

10. The system of claim 1, wherein the fluid application system is integrated with at least one of a guidance platform, a mapping service, or an automation system, and the electronic controller is configured to receive geofencing data to automatically toggle among droplet size targets.

11. The system of claim 1, wherein the regulating device comprises at least one of a pump with variable speed control and a regulating valve configured to divert flow to the tank.

12. The system of claim 1, wherein the electronic controller comprises a processor and memory storing lookup tables of nozzle attributes and control logic including pressure control loops, PWM allocation algorithms, turn compensation logic, and fault handling.

13. A method of controlling a fluid application system having a boom with a plurality of dispense points each with a pulse-width modulation (PWM) nozzle, the method comprising:
receiving pressure feedback from at least one pressure sensor associated with the boom or a section of the boom;
determining, by an electronic controller, a dynamic pressure operating range with a minimum pressure bound and a maximum pressure bound;
selecting a droplet size target based on nozzle attribute data or field attribute data;
commanding a pressure regulating device to maintain pressure within the dynamic pressure operating range; and
allocating PWM nozzle duty cycle among the plurality of dispense points to collectively satisfy a target application rate while maintaining the droplet size target.

14. The method of claim 13, further comprising:
detecting a turn condition;
commanding graduated section pressures across the boom to provide increased flow capacity at an outer portion of the boom and reduced pressure at an inner portion of the boom; and
adjusting PWM nozzle duty cycles per dispense point to compensate for localized speed differentials during the turn.

15. The method of claim 13, further comprising automatically toggling between droplet size targets based on geofenced buffer zones, headlands, or adjacent sensitive crops, and adjusting the dynamic pressure operating range accordingly.

16. The method of claim 16, further comprising prioritizing lowest feasible PWM nozzle duty cycles within the dynamic pressure operating range.

17. The method of claim 13, wherein the electronic controller comprises a processor and memory storing lookup tables of nozzle attributes and control logic including pressure control loops, PWM allocation algorithms, turn compensation logic, and fault handling.

18. The method of claim 13, wherein the pressure regulating device comprises at least one of a pump with variable speed control and a regulating valve configured to divert flow to a tank.

19. A controller for a fluid application system comprising:
(a) one or more communication interfaces configured to receive pressure feedback from at least one pressure sensor and to transmit control commands to a pressure regulating device and to PWM nozzles at a plurality of dispense points;
(b) a memory storing nozzle attribute data including at least one of minimum pressure limits, maximum pressure limits, and mappings between pressure and volumetric median droplet diameter (VMD); and
(c) a processor configured to execute control logic that:
(i) determines a dynamic pressure operating range based on the nozzle attribute data;
(ii) commands pressure within the dynamic pressure operating range;
(iii) allocates PWM duty cycles among the plurality of dispense points to meet a target application rate while maintaining a droplet size target; and
(iv) during turns, commands graduated section pressures across a boom and adjusts PWM duty cycles to increase effective turndown ratio and avoid saturation or minimum-duty conditions.

20. The controller of claim 19, wherein the pressure regulating device comprises at least one of a pump with variable speed control and a regulating valve configured to divert flow to a tank.
